(19) United States
(12) Patent Application Publication
(10) Pub. No.: US 2012/0301078 A1
(43) Pub. Date: Nov. 29, 2012

(54) DOUBLE-VARIABLE-CURVATURE LENSED FIBER

(76) Inventors: Wood-Hi Cheng, Kaohsiung City (TW); Ying-Chien Tsai, Kaohsiung City (TW); Yu-Da Liu, Taichung City (TW); Li-Jin Wang, Kaohsiung City (TW)

(21) Appl. No.: 13/339,707

(22) Filed: Dec. 29, 2011

(30) Foreign Application Priority Data
May 25, 2011 (TW) 100118326

(51) Int. Cl. G02B 6/32

(52) U.S. Cl. 385/33

(57) ABSTRACT

A double-variable-curvature lensed fiber includes a cylindrical fiber body defining a central axis, and a lens body connected integrally to one end of the fiber body. The lens body has first and second inclined curved surfaces disposed respectively at opposite sides of an imaginary plane on which the central axis is disposed, and a light-transmissive portion formed between the first and second inclined curved surfaces. The light-transmissive portion has a first radius of curvature when viewed from a first direction, and a second radius of curvature when viewed from a second direction. The second radius of curvature is different from the first radius of curvature.

### CROSS-REFERENCE TO RELATED APPLICATION

This application claims priority of Taiwanese Application No. 100118326, filed on May 25, 2011.

### BACKGROUND OF THE INVENTION

1. Field of the Invention

The present invention relates to a lensed fiber, more particularly to a double-variable-curvature lensed fiber.

2. Description of the Related Art

Referring to FIG. 1, an Er-doped fiber amplifier (EDFA) 1 includes a pump laser source 11, an Er-doped fiber 12, optical isolators 13 and an optical coupler 14. A 980 nm high power pump laser with high gain coefficient and low noise is most commonly adopted as the pump laser source 11.

A conventional high power pump laser often adopts a design of a wider light-emitting surface for avoiding concentration of heat energy. However, this design may make optical mode field generated by the conventional high power pump laser be substantially elliptical in shape, such that an issue of mode mismatch between the elliptical optical mode field and a circular optical mode field inside an optical fiber waveguide arises. This issue results in significant coupling loss between a pump laser and an optical fiber. For example, coupling efficiency between the 980 nm high power pump laser and a standard single-mode flat-end fiber merely ranges from 20% to 35%.

Conventional methods for improving mode matching between a laser and an optical fiber so as to effectively guide laser beams into the optical fiber may be classified into the following three types: changing a structure of the laser so as to change a laser beam mode field, providing a micro lens between the laser and the optical fiber so as to change the laser beam mode field, and directly processing an end face of the optical fiber so as to form the micro lens. The micro lens is configured to vary mode of a laser source by means of optical path difference resulting from passage of the laser beams through the micro lens, so that the mode matching between the laser and the optical fiber may be achieved after the laser beams enter the optical fiber.

Referring to FIG. 2, U.S. Patent Application Publication No. 2005/0008309 discloses a quadrangular-pyramid-shaped lensed fiber 2. One end of a flat-end optical fiber is machined once every 90 degrees so as to form a tapered region 21 which is in a shape of a quadrangular-pyramid. An apex of the tapered region 21 is fused by electric arcs so as to form the quadrangular-pyramid-shaped lensed fiber 2.

However, four-times of machining and fusing are required with manufacturing the quadrangular-pyramid-shaped lensed fiber 2. Therefore, more time is needed during manufacture, and it is relatively hard to precisely control an offset of the quadrangular-pyramid-shaped lensed fiber 2 during the four-times of machining.

Referring to FIG. 3, U.S. Patent Application Publication No. 2007/0273056 discloses a conical-wedge-shaped lensed fiber 3. The conical-wedge-shaped lensed fiber 3 is formed through positioning a flat-end optical fiber at an angle relative to a machining plate, rotating the optical fiber and rotating the machining plate during machining so as to form a conical region, machining two opposite sides of the conical region so as to form two wedge-shaped surfaces 31, and fusing an intersection line formed between the two wedge-shaped surfaces 31.

Even though manufacture of the lensed fiber 3 requires merely three-times of machining, it is still difficult to control an offset of the two wedge-shaped surfaces 31 formed on the conical region. Moreover, a step of chemically etching the intersection line is required before fusing the intersection line, such that a method for making the conical-wedge-shaped lensed fiber 3 is relatively dangerous and may pollute the environment.

Therefore, how to simplify a manufacturing process of a lensed fiber and how to promote coupling efficiency thereof are the subjects of endeavor by the applicants of the present invention.

### SUMMARY OF THE INVENTION

Therefore, an object of the present invention is to provide a double-variable-curvature lensed fiber which may be manufactured through a simplified manufacturing process, and which promotes coupling efficiency.

Accordingly, the double-variable-curvature lensed fiber of this invention comprises a cylindrical fiber body defining a central axis, and a lens body connected integrally to one end of the fiber body. The central axis is disposed on a first imaginary plane and is perpendicular to a second imaginary plane.

The lens body has first and second inclined curved surfaces and a light-transmissive portion. The first and second inclined curved surfaces are disposed respectively at opposite sides of the first imaginary plane. Each of the first and second inclined curved surfaces is inclined relative to the second imaginary plane, inclines toward the other, and extends away from the one end of the fiber body. The light-transmissive portion is formed between the first and second inclined curved surfaces at the first imaginary plane. The light-transmissive portion has a geometric center located at the central axis. The light-transmissive portion further has a first radius of curvature when viewed from a first direction that is substantially perpendicular to the first imaginary plane, and a second radius of curvature when viewed from a second direction that is substantially transverse to the central axis and the first direction. The second radius of curvature is different from the first radius of curvature.

An effect of the present invention resides in that: by means of a structural design of the first and second inclined curved surfaces, the number of times required for grinding may be reduced, and an offset of the double-variable-curvature lensed fiber may be controlled with relative ease. Therefore, an overall shape thereof may be precisely controlled such that a step of tip elimination may be omitted during a fusing procedure when manufacturing the lensed fiber, thus reducing fabrication time and to promoting yield of the present invention. Furthermore, by means of adjusting the different first and second radii of curvature, a coupling efficiency of the double-variable-curvature lensed fiber may be further promoted.

### BRIEF DESCRIPTION OF THE DRAWINGS

Other features and advantages of the present invention will become apparent in the following detailed description of the two preferred embodiments with reference to the accompanying drawings, of which:

FIG. 1 is a schematic diagram illustrating a Conventional Er-doped fiber amplifier;

FIG. 2 is a perspective view illustrating an embodiment of a quadrangular-pyramid-shaped lensed fiber disclosed in U.S. Patent Application Publication No. 2005/0008309;

FIG. 3 is a perspective view illustrating an embodiment of a conical-wedge-shaped lensed fiber disclosed in U.S. Patent Application Publication No. 2007/0273056;

FIG. 4 is a perspective view illustrating a first preferred embodiment of a double-variable-curvature lensed fiber according to the present invention;

FIG. 5 is a side view illustrating the first preferred embodiment when viewed from a first direction;

FIG. 6 is a side view illustrating the first preferred embodiment when viewed from a second direction;

FIG. 7 is a partly enlarged side view illustrating a first radius of curvature of a light-transmissive portion viewed from the first direction;

FIG. 8 is a partly enlarged side view illustrating a second radius of curvature of the light-transmissive portion viewed from the second direction;

FIG. 9 is a perspective view illustrating a second preferred embodiment of the double-variable-curvature lensed fiber according to the present invention; and

FIG. 10 is a statistical chart illustrating a result of a coupling efficiency experiment on twenty pieces of the second preferred embodiment of the double-variable-curvature lensed fiber of this invention.

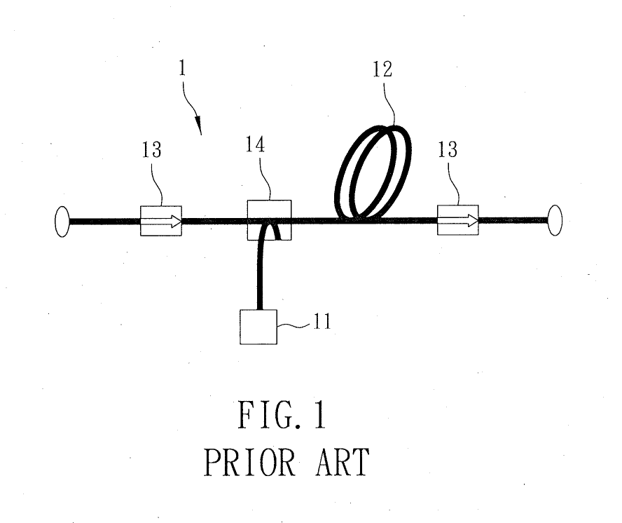

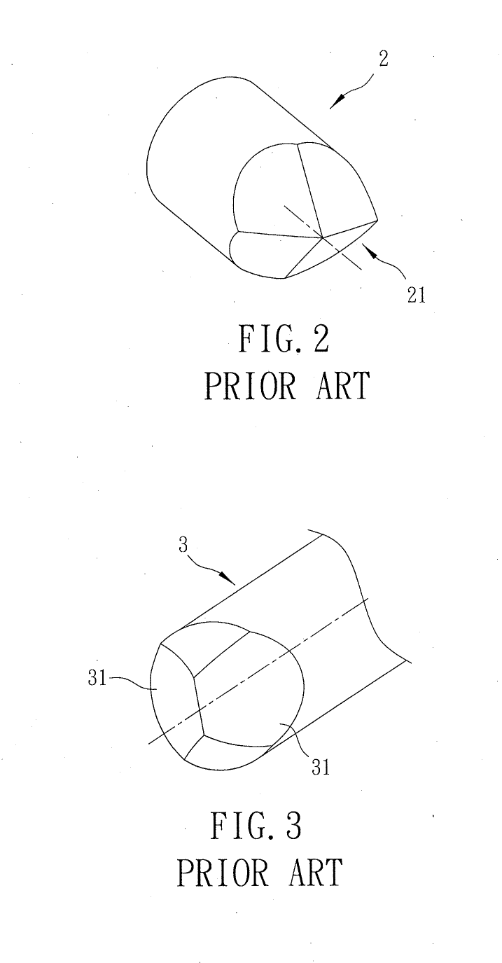

### DETAILED DESCRIPTION OF THE PREFERRED EMBODIMENTS

Before the present invention is described in greater detail with reference to the preferred embodiments, it should be noted that the same reference numerals are used to denote the same elements throughout the following description.

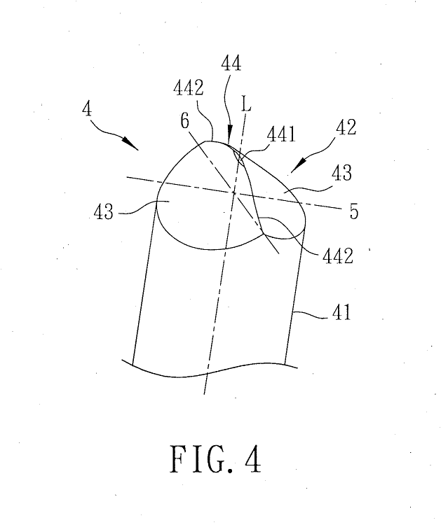

Referring to FIG. 4, a first preferred embodiment of a double-variable-curvature lensed fiber 4, according to the present invention, comprises a cylindrical fiber body 41 defining a central axis (L), and a lens body 42 that is connected integrally to one end of the fiber body 41 and that is substantially elliptic-conical in shape. The central axis (L) is disposed on a first imaginary plane and is perpendicular to a second imaginary plane.

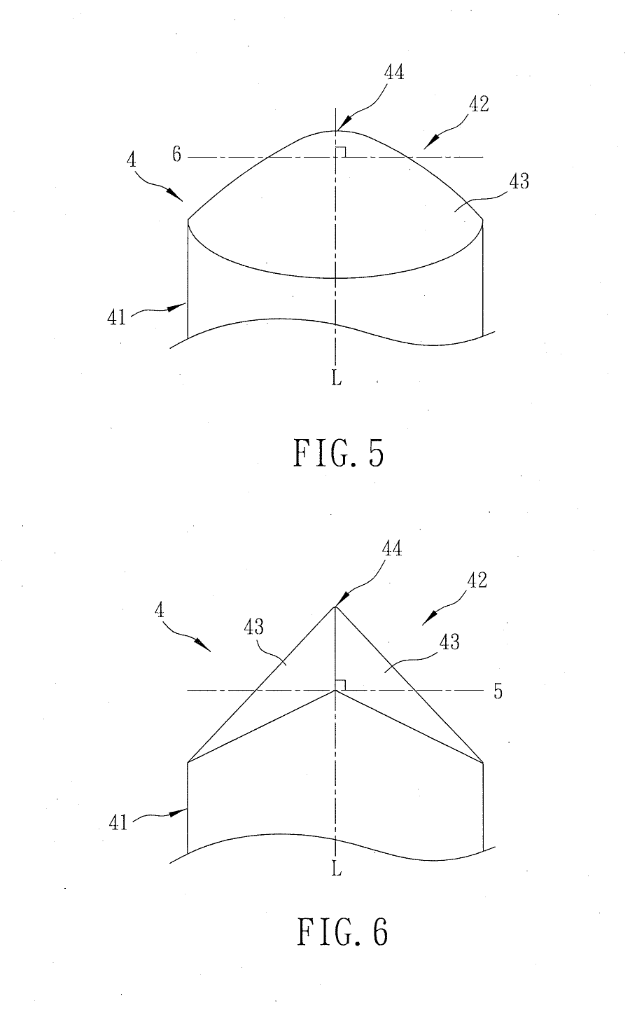

Referring to FIG. 5 and FIG. 6, in combination with FIG. 4, the lens body 42 has first and second inclined curved surfaces 43 and a light-transmissive portion 44. The lens body 42 is ground to form the first and second inclined curved surfaces 43. The first and second inclined curved surfaces 43 are disposed respectively at opposite sides of the first imaginary plane. Each of the first and second inclined curved surfaces 43 is inclined relative to the second imaginary plane, inclines toward the other, and extends away from the one end of the fiber body 41. The light-transmissive portion 44 is formed between the first and second inclined curved surfaces 43 at the first imaginary plane. The light-transmissive portion 44 has a geometric center located at the central axis (L). In this embodiment, the light-transmissive portion includes a generally elliptic surface 441 having a geometric center serving as the geometric center of the light-transmissive portion 44, and two curved segments 442 each interconnecting the generally elliptic surface 441 and the fiber body 41.

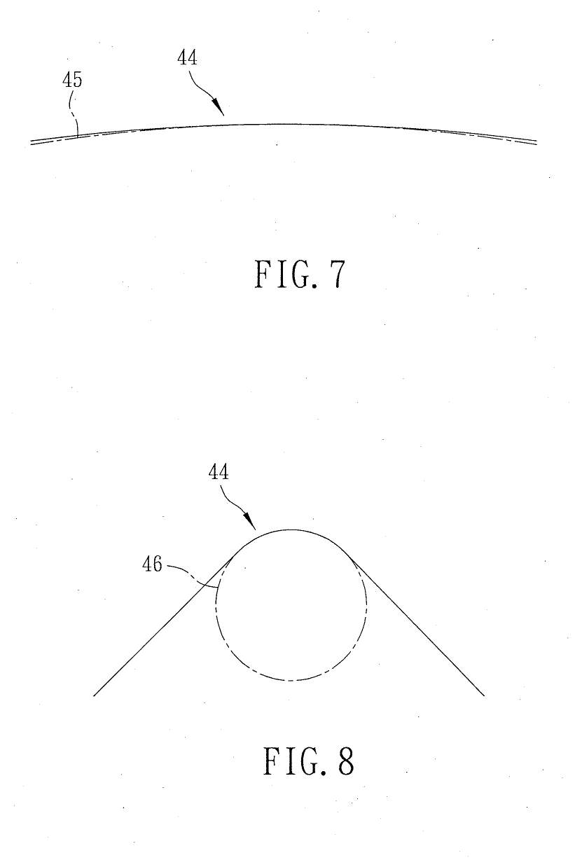

Referring to FIG. 7 and FIG. 8, in combination with FIG. 4, the light-transmissive portion 44 further has a first radius of curvature 45 when viewed from a first direction 5 that is substantially perpendicular to the first imaginary plane, and a second radius of curvature 46 when viewed from a second direction 6 that is substantially transverse to the central axis (L) and the first direction 5. The first radius of curvature 45 is greater than the second radius of curvature 46.

It should be noted that, as used herein, “double-variable-curvature” means the lens body 42 has two noncircular contours when viewed from the first and second directions 5, 6.

By means of a structural design of the first and second inclined curved surfaces 43, the number of times required for grinding may be reduced so as to achieve a single-step grinding fabrication, and an offset of the double-variable-curvature lensed fiber 4 may be controlled with relative ease. Therefore, an overall shape of the lensed fiber 4 may be precisely controlled such that a step of tip elimination may be omitted during a fusing procedure when manufacturing the same, thus reducing fabrication time and promoting yield of the present invention.

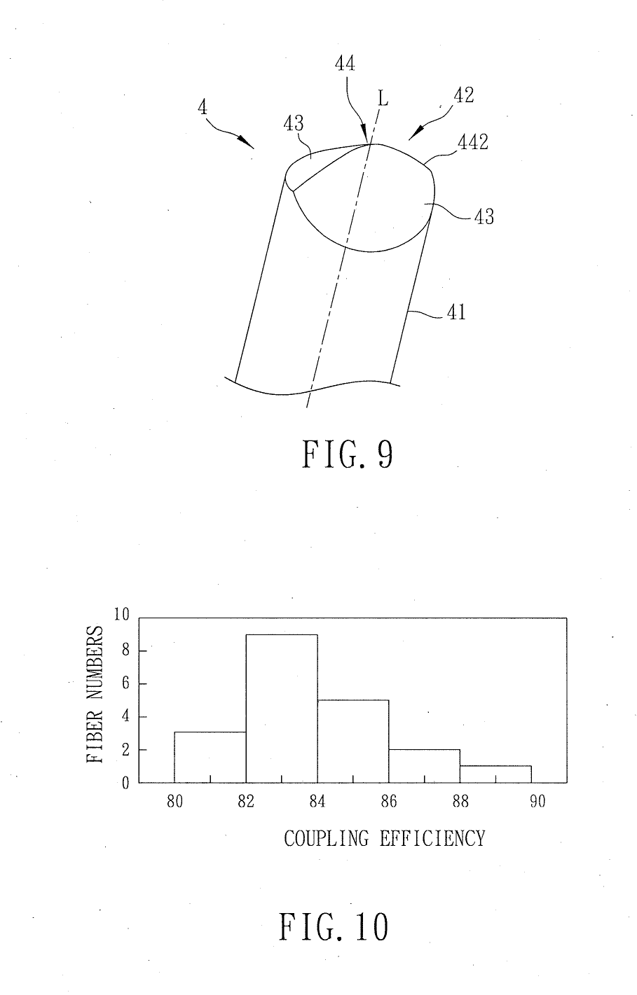

Referring to FIG. 9, a second preferred embodiment of the double-variable-curvature lensed fiber 4, according to the present invention, is substantially similar to the first preferred embodiment, and comprises a cylindrical fiber body 41 defining a central axis (L), and a lens body 42 that is connected integrally to one end of the fiber body 41 and that is substantially elliptic-conical in shape. The second preferred embodiment differs from the first preferred embodiment in the configurations that the light-transmissive portion 44 is a curved segment 442 formed by intersection of the first and second inclined curved surfaces 43 with each other at the first imaginary plane. The central axis (L) passes through a center point of the curved segment 442.

It should be noted that, in practical application, the second preferred embodiment is manufactured through applying slight arc fusion on the lens body 42 of the first preferred embodiment. Parameters of the slight arc fusion are set as follows: arc discharge intensity: 3 bit, fusing time: 200 ms, and fusing distance between the light-transmissive portion 44 and the fusing boundary: 10 μm. It is apparent from FIG. 4 and FIG. 9 that the first preferred embodiment is quite similar in shape to the second preferred embodiment, and the slight arc fusion is merely adopted for fine polishing but not for tip elimination. Therefore, the second preferred embodiment has the advantages of a reduced fabrication time and a high yield as well.

Referring to Table 1, twenty pieces of the double-variable-curvature lensed fibers 4 designated as numbers from 1 to 20 underwent an arc fusion test. Owing to a structural restriction and an effect of surface tension, the arc fusion process is capable of reducing an offset between the geometric center of the light-transmissive portion 44 and the central axis (L) of the fiber body 41 from 0.3 μm to 0.2 μm, capable of increasing an average of the first radius of curvature 45 (see FIG. 7) from 33.6 μm to 38.1 μm, and capable of increasing an average of the second radius of curvature 46 (see FIG. 8) from 1.2 μm to 2.5 μm. It should be noted that the aforementioned results are obtained through capturing appearance images of the twenty pieces of the double-variable-curvature lensed fiber 4 using an optical microscope, and analyzing the appearance images using an ImageJ software available from National Institute of Health (NIH).

TABLE 1

| | | | First radius of | | Second radius of | |
|---|---|---|---|---|---|---|
| | Offset (μm) | | curvature (μm) | | curvature (μm) | |
| | Before | After | Before | After | Before | After |
| No. | test | test | test | test | test | test |
| 1 | 0.5 | 0.1 | 26.0 | 27.7 | 1.2 | 3.2 |
| 2 | 0.1 | 0.2 | 35.3 | 22.9 | 1.1 | 3.1 |
| 3 | 0.1 | 0.1 | 48.0 | 30.6 | 1.1 | 2.4 |
| 4 | 0.3 | 0.2 | 44.9 | 27.8 | 1.4 | 3.3 |
| 5 | 0.3 | 0 | 40.0 | 26.5 | 1.6 | 2.8 |
| 6 | 0.3 | 0.3 | 43.2 | 42.7 | 1.4 | 3.6 |
| 7 | 0.1 | 0.1 | 21.9 | 33.1 | 0.8 | 3.1 |
| 8 | 0.6 | 0.4 | 27.0 | 40.7 | 1.2 | 2.9 |
| 9 | 0.2 | 0.3 | 22.7 | 51.8 | 1.0 | 2.6 |
| 10 | 0.2 | 0.5 | 23.6 | 46.5 | 1.3 | 2.6 |
| 11 | 0.3 | 0.1 | 28.9 | 48.9 | 1.2 | 2.7 |
| 12 | 0.6 | 0.4 | 36.2 | 60.4 | 0.8 | 2.7 |
| 13 | 0.2 | 0.2 | 35.4 | 32.2 | 1.1 | 2.7 |
| 14 | 0.5 | 0 | 36.5 | 36.3 | 1.1 | 2.6 |
| 15 | 0.4 | 0.3 | 26.3 | 29.9 | 0.9 | 2.9 |
| 16 | 0.2 | 0.2 | 27.9 | 29.3 | 0.9 | 2.8 |
| 17 | 0.1 | 0.1 | 26.8 | 34.2 | 1.4 | 2.8 |
| 18 | 0.4 | 0.3 | 42.4 | 51.3 | 1.4 | 3.4 |
| 19 | 0.1 | 0 | 57.4 | 53.4 | 1.4 | 3.3 |
| 20 | 0.5 | 0.7 | 21.5 | 36.0 | 1.4 | 2.7 |
| Avg. | 0.3 | 0.2 | 33.6 | 38.1 | 1.2 | 2.9 |

For the purpose of verifying an effect of the double-variable-curvature lensed fiber 4 according to the present invention, a 980 nm single-mode laser was adopted for performing a coupling efficiency experiment on twenty pieces of the second preferred embodiment of the double-variable-curvatures lensed fiber 4. The light-transmissive portion 44 of each of the twenty pieces of the double-variable-curvature lensed fibers 4 has the first radius of curvature 45 (see FIG. 7) that ranges from 30 μm to 60 μm, and the second radius of curvature 46 (see FIG. 8) that ranges from 2.4 μm to 34 μm. A result of the coupling efficiency experiment is illustrated in FIG. 10, in which the best coupling efficiency is 88%, an average coupling efficiency is 83%, and all of the coupling efficiencies are greater than 80%.

It is apparent from Table 2 that the double-variable-curvature lensed fiber 4 of the present invention, compared with a conventional conical-wedge-shaped lensed fiber and a conventional quadrangular-pyramid-shaped lensed fiber, indeed has relatively high coupling efficiency and relatively small offset.

TABLE 2

| | Quadrangular- | Conical- | Double- |
|---|---|---|---|
| | pyramid- | wedge- | Variable- |
| Structure | shaped | shaped | curvature |
| Best | 83% | 84% | 88% |
| coupling | | | |
| efficiency | | | |
| Average | N/A | 71% | 83% |
| coupling | | | |
| efficiency | | | |
| Average | 1.5 | 0.9 | 0.2 |
| offset (μm) | | | |

In summary, the double-variable-curvature lensed fiber 4 of the present invention adopts the structural design of the first and second inclined curved surfaces 43 so as to effectively reduce the number of times required for grinding, and to control the offset with relative ease. Therefore, the overall shape may be precisely controlled such that the step of tip elimination may be omitted, thus reducing the fabrication time and promoting the yield of the present invention. Moreover, by means of adjusting the different first and second radii of curvature 45, 46 of the light-transmissive portion 44, the coupling efficiency may be further promoted.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A double-variable-curvature lensed fiber comprising:
a cylindrical fiber body defining a central axis that is disposed on a first imaginary plane and that is perpendicular to a second imaginary plane; and
a lens body connected integrally to one end of said fiber body, said lens body having
first and second inclined curved surfaces disposed respectively at opposite sides of the first imaginary plane, each of said first and second inclined curved surfaces being inclined relative to the second imaginary plane, inclining toward the other, and extending away from said one end of said fiber body, and
a light-transmissive portion formed between said first and second inclined curved surfaces at the first imaginary plane, said light-transmissive portion having a geometric center located at the central axis, said light-transmissive portion further having a first radius of curvature when viewed from a first direction that is substantially perpendicular to the first imaginary plane, and a second radius of curvature when viewed from a second direction that is substantially transverse to the central axis and the first direction, the second radius of curvature being different from the first radius of curvature.

2. The double-variable-curvature lensed fiber as claimed in claim 1, wherein the first radius of curvature is greater than the second radius of curvature.

3. The double-variable-curvature lensed fiber as claimed in claim 2, wherein said lens body is generally elliptic-conical in shape.

4. The double-variable-curvature lensed fiber as claimed in claim 1, wherein said lens body is generally elliptic-conical in shape.

5. The double-variable-curvature lensed fiber as claimed in claim 3, wherein said light-transmissive portion is a curved segment formed by intersection of said first and second inclined curved surfaces with each other at the first imaginary plane, the central axis passing through a center point of said curved segment.

6. The double-variable-curvature lensed fiber as claimed in claim 4, wherein said light-transmissive portion is a curved segment formed by intersection of said first and second inclined curved surfaces with each other at the first imaginary plane, the central axis passing through a center point of said curved segment.

7. The double-variable-curvature lensed fiber as claimed in claim 3, wherein said light-transmissive portion includes:
a generally elliptic surface having a geometric center serving as the geometric center of said light-transmissive portion; and
two curved segments each interconnecting said generally elliptic surface and said fiber body.

8. The double-variable-curvature lensed fiber as claimed in claim 4, wherein said light-transmissive portion includes:
a generally elliptic surface having a geometric center serving as the geometric center of said light-transmissive portion; and
two curved segments each interconnecting said generally elliptic surface and said fiber body.
